(19) United States
(12) Patent Application Publication
(10) Pub. No.: US 2005/0104850 A1
(43) Pub. Date: May 19, 2005

(54) Cursor simulator and simulating method thereof for using a limb image to control a cursor

(76) Inventors: Chia-Chang Hu, Tao Yuan City (TW); Xiaohong Wei, Tao Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/713,010

(22) Filed: Nov. 17, 2003

(51) Int. Cl. G09G 5/08

(52) U.S. Cl. 345/157

(57) ABSTRACT

The present invention relates to a cursor simulator and a simulation method thereof for using a limb image to control a cursor. The cursor simulator has a receiving module for receiving optical signals; a position corresponding module for corresponding the view scope to the display frame; a display module for finding out the position on the display frame, and displaying the optical signal on a simulation display frame; a specific area display module for marking a specific area; a limb image color parameter acquiring module for reading the color parameters in an area corresponding to the specific area; and a limb image forming module for reading the color parameters. When the color parameter is approximately equal to the limb image color parameter, the forming module will record the optical signal display position, and form a simulated limb image according to all of the recorded optical signal display positions.

### BACKGROUND OF THE INVENTION

1. Field of the Invention

The present invention relates to a cursor simulator and a simulating method thereof for using a limb image to control a cursor, and particularly, to a cursor simulator and a simulating method thereof for using a limb image of a user to control the position of a cursor and to generate commands.

2. Description of the Prior Art

As information technology advances with high speed, computers have become necessary for nearly everyone. No matter what the occasion, an input device is required when a computer is to be used. Nowadays, the most common input devices are the mouse and the keyboard.

However, it is not very convenient to use the wired mouse as an input device. Thus, many manufacturers have developed the wireless mouse by applying the wireless communication protocol in order to overcome the inconvenience of the wired mouse.

Although it is convenient to use the wireless mouse as the input device during presentations, such use may constrain the natural body language of the. presenter. Therefore, some manufacturers have developed technology that uses the presenter's body language to send out directly commands to the computer. For example, in the technology field of virtual reality (VR), various hand postures send out the commands to the computer. This will overcome the inconvenience of using the wired mouse and the physical mouse.

However, in the above mentioned prior art, the computer has to have a extremely high capability for calculation and image processing because it has to deal with a considerable amount of data. This requirement is impractical and hard to meet for the general users. Therefore, the mentioned VR technology cannot be applied for the general use.

Therefore, the present invention provides a cursor simulator and its simulating method for using a limb image to control a cursor so as to resolve the above mentioned problem. The cursor simulator is a cursor simulation software, and by installing this software in the computer, the user can operate the video camera in coordination with the movement of the hand and the variation of the posture so as to control remotely the cursor.

### SUMMARY OF THE INVENTION

The present invention relates to a cursor simulator and its simulating method for using a limb image to control a cursor. The limb image of the user is applied to control the position of the cursor and to generate commands so as to replace the traditional cursor control device, such as a mouse, a joystick, or a pointer.

The cursor simulator according to the present invention is installed in a main system. The main system comprises a display device having a predetermined display frame for displaying a cursor. The main system is connected to an optical reading device having a predetermined view scope. When the optical reading device receives a plurality of optical signals, it will transmit the optical signals to the main system, and the main system will transmit the optical signals to the cursor simulator. The cursor simulator comprises a receiving module for receiving the optical signals. A position corresponding module corresponds the view scope of the optical reading device to the display frame of the display device so that each position in the view scope corresponds to a position on the display frame. A display module detects the position on the display frame corresponding to the position of the optical signal in the view scope, and displays the optical signal on a simulation display frame. The simulation display frame comprises a plurality of optical signal display positions, and each optical signal display position corresponds to a specific position on the display frame. A specific area display module marks a specific area on the display frame. A limb image color parameter acquiring module reads the color parameter of each optical signal display position in an area on the simulation display frame corresponding to the specific area of the display frame so as to obtain a limb image color parameter according to the variation of the color parameter of the optical signal display position. A limb image forming module reads the color parameter of each optical signal display position on the simulation display frame. When the color parameter is approximately equal to the limb image color parameter, the limb image forming module will record the optical signal display position, and then form a simulated limb image according to all of the recorded optical signal display positions.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram showing the application of a cursor simulator according to the present invention;

FIG. 2 is a perspective diagram of a cursor simulator according to the present invention; and

FIG. 3 is a flowchart of a cursor simulating method according to the present invention.

### DETAILED DESCRIPTION OF THE PREFERRED EMBODIMENT

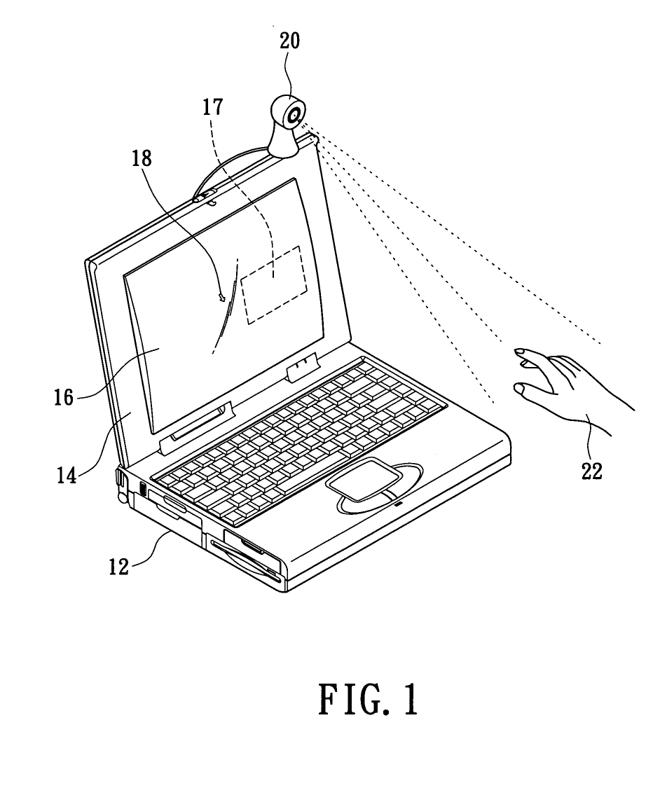

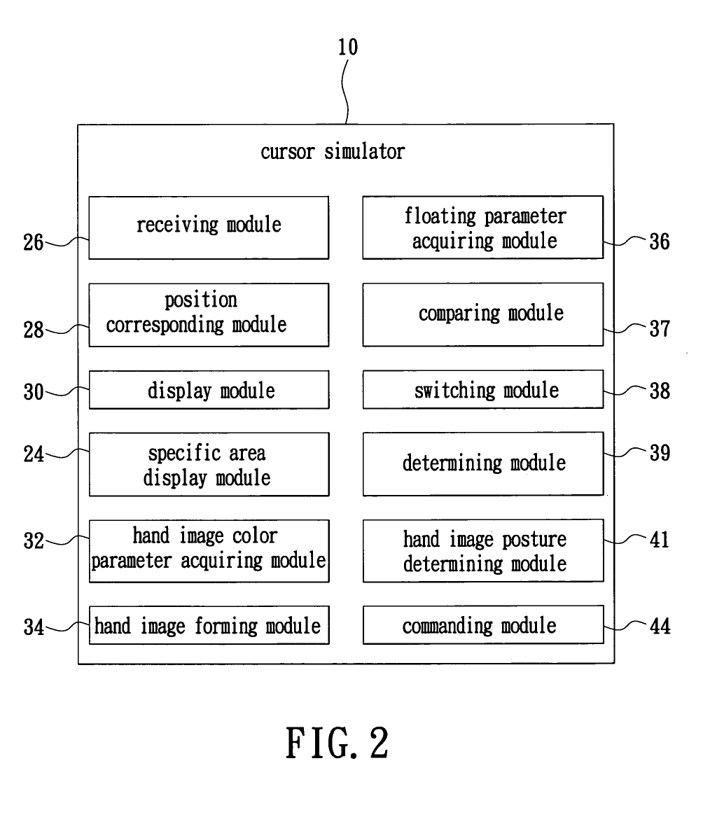

Reference is made to FIG. 1. FIG. 1 is a perspective diagram showing the application of a cursor simulator 10 according to the present invention. The cursor simulator (as shown in FIG. 2) is a cursor simulation software installed in a main system 12. As shown in the figure, in this embodiment, the main system 12 is a notebook. The main system 12 comprises a display device 14 having a predetermined display frame 16 for displaying a cursor 18. The main system 12 is connected to an optical reading device 20, such as a camera. The optical reading device 20 has a predetermined view scope 22. When the optical reading device 20 receives the optical signals, it will transmit the optical signals to the main system 12. The main system 12 will transmit the optical signals to the cursor simulator 10.

Reference is made to FIG. 2. FIG. 2 is a perspective diagram of a cursor simulator 10 according to the present invention. The cursor simulator 10 comprises a receiving module 26, a position corresponding module 28, a display module 30, a specific area display module 24, a hand image color parameter acquiring module 32, a hand image forming module 34, a floating parameter acquiring module 36, a comparing module 37, a switching module 38, a determining module 39, a hand image posture determining module 41, and a commanding module 44.

The receiving module 26 is used for receiving the optical signals. The position corresponding module 28 is used for corresponding the view scope 22 of the optical reading device 20 to the display frame 16 of the display device 14 so that each position in the view scope 22 corresponds to a position on the display frame 16.

The display module 30 is used for detecting the position on the display frame 16 corresponding to the position of the optical signal in the view scope 22, and displaying the optical signal on a simulation display frame (not shown). The simulation display frame comprises a plurality of optical signal display positions, and each optical signal display position corresponds to a specific position on the display frame 16.

The specific area display module 24 is used for marking a specific area 17 on the display frame 16. The hand image color parameter acquiring module 32 is used for reading the color parameter of each optical signal display position in an area on the simulation display frame corresponding to the specific area 17 of the display frame 16 so as to obtain a hand image color parameter according to the variation of the color parameter of the optical signal display position.

The floating parameter acquiring module 36 is used for acquiring a floating parameter according to the different color parameters of the optical signals displayed on the simulation display frame in different times. Even in a stable environment, the color parameters of the specific image read in the different times by the optical reading device 20 will be different. Namely, there is an error range in the color parameter. Therefore, the cursor simulator 10 will apply the floating parameter acquiring module 36 to find the error value. The floating parameter acquiring module 36 will read the color parameters of the specific image in the specific area in the different times, and obtain the difference between the two neighboring color parameters, namely, the error value of the two neighboring color parameters, so as to find out the floating parameter. The user can set the floating parameter acquiring module 36 to perform a specific number of readings so as to obtain widespread sampling. In this embodiment, the floating parameter acquiring module 36 chooses the maximum value in all of the calculated error values as the floating parameter.

The hand image forming module 34 is used for reading the color parameter of each optical signal display position on the simulation display frame. When the color parameter is approximately equal to the hand image color parameter, the hand image forming module 34 will record the optical signal display position, and then form a simulated hand image according to all of the recorded optical signal display positions. The color parameter is approximately equal to the hand image color parameter when the difference between the color parameter and the hand image color parameter is less than or equal to the floating parameter.

The comparing module 37 is used for comparing the positions of the simulated hand image formed by the hand image forming module 34 at different times so as to generate a position comparing result. The switching module 38 is used for switching the cursor simulator 10 between a command mode and a movement mode. The determining module 39 is used for determining whether the simulated hand image is moving in a specific period, such as three seconds, according to the position comparing result generated by the comparing module 37. If yes, then the cursor simulator 10 is in the movement mode. If no, then the cursor simulator 10 is switched to the command mode.

When the cursor simulator 10 is in the movement mode, the cursor simulator 10 will determine the relative movement of the simulated hand image according to the position comparing result generated by the comparing module 37, and move the cursor 18 displayed on the display frame 16 according to the relative movement. For example, when the following simulated hand image moves downward relative to the preceding simulated hand image, the cursor simulator 10 will move downward the cursor 18. The movement range of the cursor 18 is pre-set by the user.

The hand image posture determining module 41 is used for determining the posture of the simulated hand image formed by the hand image forming module 34. When the cursor simulator 10 is in the command mode, the hand image posture determining module 41 will generate a command code according to the posture of the simulated hand image.

The commanding module 44 has a command table (not shown). The command table comprises a plurality of commands and a plurality of command codes. Each command corresponds to a command code. The commanding module 44 will find the command corresponding to the command code generated by the hand image posture determining module 41 so that the cursor simulator 10 will send out the command.

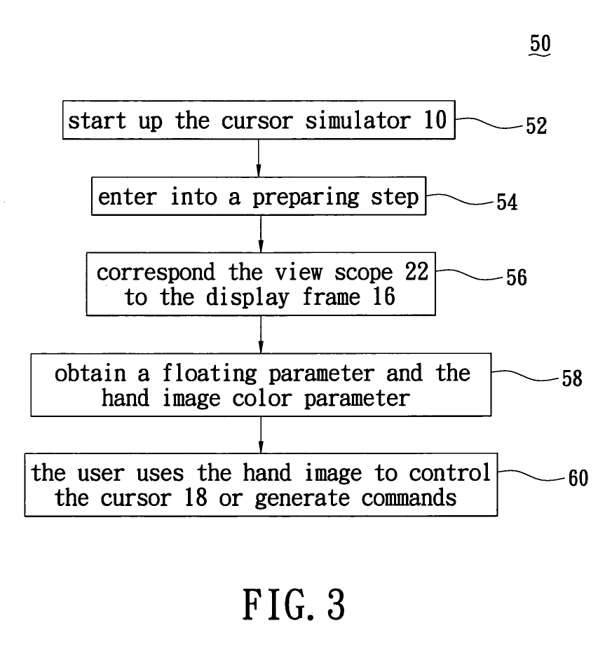

Reference is made to FIG. 3. FIG. 3 is a flowchart of a cursor simulating method. 50 according to the present invention. Initially, the user has to start up the cursor simulator 10 (step 52). Thereafter, the cursor simulator 10 will enter into a preparation step where the operating system of the main system 12 will prepare to simulate the cursor (step 54). Then, the position corresponding module 28 will correspond the view scope 22 of the optical reading device 20 to the display frame 16 of the display device 14 (step 56).

The user can set the optical reading device 20 to correspond automatically the view scope 22 to the display frame 16, namely, to automatically set the view scope 22 of the optical reading device 20. It also can be set that the cursor simulator 10 will ask the user to set manually the view scope 22 of the optical reading device 20 after the operating system of the main system 12 finishes the preparation for simulating the cursor. Once the view scope 22 is determined, the user has to move his/her hand and change the hand posture within the view scope 22 so as to control the cursor and send commands.

In the step 58, the cursor simulator 10 will use the floating parameter acquiring module 36 to obtain a floating parameter, and use the hand image color parameter acquiring module 32 to obtain the hand image color parameter of the hand image. The specific area display module 24 will display a specific area 17 on the display frame 16. For example, a green bold line is used for circumscribing and marking the specific area 17, and the user has to put the hand image within this specific area 17. Therefore, the hand image color parameter acquiring module 32 can obtain the hand image color parameter of the hand image according to the variation of the color parameter of each position in the specific area 17 before and after the hand image enters the specific area 17. The user can set the hand image color parameter acquiring module 32 to read the hand image color parameter of the hand image a specific number of times for widespread sampling.

The user can use the switching module 38 to set the cursor simulator 10 to the movement mode or the command mode. At this time, the user can use the hand image to control the cursor 18 on the display frame 16 or generate commands (step 60). When the user moves the hand, the cursor simulator 10 will be maintained in the movement mode to control the movement of the cursor 18. If the user wants to set the cursor simulator 10 in the command mode for generating commands, the user can stop moving the hand for a predetermined period, such as three seconds. Therefore, the determining module 39 will determine that the simulated hand image has stopped moving for the predetermined period, and the cursor simulator 10 will enter the command mode.

When the cursor simulator 10 is in the movement mode, the user can control the position of the cursor 18 by moving the position of the hand image. Under the movement mode, the comparing module 37 will compare the positions of the simulated hand image formed in the different times by the hand image forming module 34 so as to generate a position comparing result. The cursor simulator 10 will determine the relative movement of the simulated hand image according to this position comparing result, and move the cursor 18 displayed on the display frame 16 according to the relative movement. Therefore, when the position of the hand image in the view scope 22 changes, the position of the cursor 18 will correspondingly change.

When the cursor simulator 10 is in the command mode, the user can use the hand image to generate various commands. For example, lifting the forefinger to swing down once represents a command equal to that generated by pressing the left key on the mouse once, lifting the forefinger to swing down twice represents a command equal to that generated by pressing the left key on the mouse twice, and lifting the ring finger represents a command equal to that generated by releasing the left key on the mouse.

Under the command mode, the hand image posture determining module 41 will determine the posture of the simulated hand image formed by the hand image forming module 34 so as generate the command code. The hand posture formed by the hand image forming module 34 can be the lifting a specific finger. For example, lifting the thumb, the forefinger, and the middle finger separately represent various command codes. At this time, the commanding module 44 will use the command table to find the corresponding command so that the cursor simulator 10 will send out this command. For example, lifting the thumb represents the command equal to pressing the left key on the mouse once, lifting the forefinger represents the command generated by pressing the left key on the mouse twice, and lifting the middle finger represents the command generated by pressing the right key on the mouse.

Further, the user also can use the cursor simulator 10 to set various commands, such as the command for adjusting the volume, the command for directly executing a specific program, and so on.

In summary, by using the cursor simulator 10 and its simulating method 50 according to the present invention, the user only has to install the cursor simulation software (the cursor simulator 10) in the computer (the main system 12), and then the user can operate a common camera (the optical reading device 20) in coordination with the movement of the hand and the variation of the hand posture so: as to remotely control the cursor. The camera will read the user's hand image, and the cursor simulator 10 will use the variation of the position of the hand image to simulate the movement of the cursor, and use the variation of the hand posture to simulate the different commands. Therefore, the user can use the hand image to control the position of the cursor and send the various commands so as to replace the traditional cursor control device, such as the mouse, the joystick or the pointer.

Therefore, by using the cursor simulator 10 and its simulating method 50 according to the present invention, the user can remotely control the position of the cursor and the operation of the computer during the presentation. This will make the presentation process smoother and more efficient. Additionally, because the user uses the hand image to control the cursor, the interference of radios waves, infrared rays, or ultrasonic waves will not happen.

Furthermore, the optical reading device 20 applied in the present invention is the common video camera. The user has only to install the cursor simulation software in the computer, and does not have to further buy other computer peripheral devices. In this way, “electronic garbage” will not be generated. Further, it is extremely electrically economical to use the optical reading device 20 as the input device, and therefore, the optical reading device 20 can applied in any portable product, such as a notebook, or personal digital assistant (PDA).

Those skilled in the art will readily observe that numerous modifications and alterations of the device may be made while retaining the teachings of the invention. Accordingly, the above disclosure should be construed as limited only by the metes and bounds of the appended claims.

1. A cursor simulator installed in a main system, the main system comprising a display device having a predetermined display frame for displaying a cursor, the main system is connected to an optical reading device having a predetermined view scope, wherein when the optical reading device receives a plurality of optical signals, the optical reading device transmits the optical signals to the main system, and the main system transmits the optical signals to the cursor simulator, the cursor simulator comprising:
a receiving module for receiving the optical signals;
a position corresponding module for corresponding the view scope of the optical reading device to the display frame of the display device so that each position in the view scope corresponds to a position on the display frame;
a display module for detecting the position on the display frame corresponding to the position of the optical signal in the view scope, and displaying the optical signal on a simulation display frame, wherein the simulation display frame comprises a plurality of optical signal display positions, and each optical signal display position corresponds to a specific position on the display frame;
a specific area display module for marking a specific area on the display frame;
a limb image color parameter acquiring module for reading the color parameter of each optical signal display position in an area on the simulation display frame corresponding to the specific area of the display frame so as to obtain a limb image color parameter according to the variation of the color parameter of the optical signal display position; and a limb image forming module for reading the color parameter of each optical signal display position on the simulation display frame, wherein when the color parameter is approximately equal to the limb image color parameter, the limb image forming module records the optical signal display position, and then form a simulated limb image according to all of the recorded optical signal display positions.

2. The cursor simulator of claim 1, wherein the limb image is a hand image.

3. The cursor simulator of claim 1, further comprising a floating parameter acquiring module for acquiring a floating parameter according to the different color parameters of the optical signals displayed on the simulation display frame at different times, wherein the color parameter is approximately equal to the wavelength parameter when a difference between the color parameter and the wavelength parameter is less than or equal to the floating parameter.

4. The cursor simulator of claim 1, further comprising a comparing module for comparing the positions of the simulated limb image formed by the limb image forming module at the different times so as to generate a position comparing result.

5. The cursor simulator of claim 3, further comprising:
a switching module for switching the cursor simulator to be in a command mode and a movement mode; and
a determining module for determining whether the simulated limb image is being moved during a specific period according to the position comparing result generated by the comparing module, wherein if yes, the cursor simulator is in the movement mode, and if no, the cursor simulator is in the command mode.

6. The cursor simulator of claim 4, wherein when the cursor simulator is in the movement mode, the cursor simulator determine s the relative movement of the simulated limb image according to the position comparing result generated by the comparing module, and moves the cursor displayed on the display frame according to the relative movement.

7. The cursor simulator of claim 4, further comprising a limb posture determining module for determining the posture of the simulated limb image formed by the limb image forming module, wherein when the cursor simulator is in the command mode, the limb posture determining module generates a command code according to the limb image.

8. The cursor simulator of claim 6, further comprising a commanding module, the commanding module having a command table comprising a plurality of commands and a plurality of command codes, each of the commands being corresponding to a command code, wherein the commanding module finds the command corresponding to the command code generated by the limb posture determining module so that the cursor simulator sends out the command.

9. The cursor simulator of claim 1, wherein the position corresponding module automatically corresponds the view scope of the optical reading device to the display frame of the display device so that each position in the view scope corresponds to a position on the display frame.

10. The cursor simulator of claim 1, wherein a user applies the position corresponding module to correspond the view scope of the optical reading device to the display frame of the display device in a manual way so as to make each position in the view scope correspond to a position on the display frame.

11. A cursor simulating method applied in a main system, the main system comprising a display device having a predetermined display frame for displaying a cursor, and a cursor simulator for executing the cursor simulating method, the main system being connected to an optical reading device having a predetermined view scope, wherein when the optical reading device receives a plurality of optical signals, the optical reading device transmits the optical signals to the main system, and the cursor simulator of the main system executes the cursor simulating method, the method comprising:
a position corresponding step for corresponding the view scope of the optical reading device to the display frame of the display device so that each position in the view scope corresponds to a position on the display frame;
a displaying step for detecting the position on the display frame corresponding to the position of the optical signal in the view scope, and displaying the optical signal on a simulation display frame, wherein the simulation display frame comprises a plurality of optical signal display positions, and each optical signal display position corresponds to a specific position on the display frame;
a specific area displaying step for marking a specific area on the display frame;
a limb image color parameter acquiring step for reading the color parameter of each optical signal display position in an area on the simulation display frame corresponding to the specific area of the display frame so as to obtain a limb image color parameter according to the variation of the color parameter of the optical signal display position; and
a limb image forming step for reading the color parameter of each optical signal display position on the simulation display frame, wherein when the color parameter is approximately equal to the limb image color parameter, the limb image forming module records the optical signal display position, and then forms a simulated limb image according to all of the recorded optical signal display positions.

12. The cursor simulating method of claim 11, further comprising a floating parameter acquiring step for acquiring a floating parameter according to the different color parameters of the optical signals displayed on the simulation display frame in different times, wherein the color parameter is approximately equal to the wavelength parameter when the difference between the color parameter and the wavelength parameter is smaller than or equal to the floating parameter.

13. The cursor simulating method of claim 11, further comprising a comparing step for comparing the positions of the simulated limb image formed in the limb image forming step in the different times so as to generate a position comparing result.

14. The cursor simulating method of claim 13, wherein the cursor simulator further comprises a switching module for switching the cursor simulator between a command mode and a movement mode, the method further comprising:
a determining step for determining whether the simulated limb image is being moved during a specific period according to the position comparing result generated in the comparing step, wherein if yes, the switching module switches the cursor simulator to the movement mode, and if no, the switching module switches the cursor simulator to the command mode.

15. The cursor simulating method of claim 14, wherein when the cursor simulator is in the movement mode, the cursor simulator determines the relative movement of the simulated limb image according to the position comparing result generated in the comparing step, and moves the cursor displayed on the display frame according to the relative movement.

16. The cursor simulating method of claim 14, further comprising a limb posture determining step for determining the posture of the simulated limb image formed in the limb image forming step, wherein when the cursor simulator is in the command mode, the limb posture determining step generates a command code according to the limb image.

17. The cursor simulating method of claim 16, further comprising a commanding module, the commanding module having a command table comprising a plurality of commands and a plurality of command codes, each command corresponding to a command code, wherein the commanding module finds the command corresponding to the command code generated in the limb posture determining step so that the cursor simulator sends out the command.

18. The cursor simulating method of claim 11, wherein the position corresponding step is automatically performed to correspond the view scope of the optical reading device to the display frame of the display device so that each position in the view scope corresponds to a position on the display frame.

19. The cursor simulating method of claim 11, wherein a user performs the position corresponding step to correspond the view scope of the optical reading device to the display frame of the display device in a manual way so as to make each position in the view scope correspond to a position on the display frame.
